(19) United States
(12) Patent Application Publication
(10) Pub. No.: US 2006/0045271 A1
(43) Pub. Date: Mar. 2, 2006

(54) Security system for apparatuses in a wireless network

(76) Inventors: Tobias Helbig, Aachen (DE); Wolfgang Otto Budde, Aachen (DE); Oliver Schreyer, Herzogenrath (DE); Armand Lelkens, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/521,719

(22) PCT Filed: Jul. 24, 2003
(86) PCT No.: PCT/IB03/02945

§ 371 Date: Sep. 29, 2005

(30) Foreign Application Priority Data
Jul. 29, 2002 (DE) 102 34 643.7
Nov. 23, 2002 (DE) 102 54 747.5

(51) Int. Cl. H04K 1/00

(52) U.S. Cl. 380/270

(57) ABSTRACT

The invention relates to a security system for wireless networks, comprising a portable unit (1) with a key unit (3) for making a key record (4, 17, 104) available and being provided for short-range information transmission of the key record (4, 17, 104). At least one wireless apparatus (2) of the network is provided with a receiving unit (7) comprising a receiver (9) for receiving the key record (4, 17, 104) and an evaluation component (11) of the apparatus for storing, processing and/or passing on the key record (4, 17, 104) or a part of the key record to a second component. Due to the key record, the apparatuses of the wireless network acquire a secret shared key with which the encryption and decryption of the transmitted useful data and/or the authentication is performed. The unit (101) may further comprise a reading device (107) for a chip card (108), which chip card (108) preferably comprises the decoding key record (104) of copy-protected digital data.

The invention generally relates to a security system for networks, particularly wireless networks.

Wireless communication for supporting mobile apparatuses (such as mobile telephones) or as a substitution for wired solutions between stationary apparatuses (for example, PC and telephone connections) are already widely used.

For future digital home networks, this means that they no longer typically consist of only a plurality of wired apparatuses but also of a plurality of wireless apparatuses. When realizing digital wireless networks, particularly home networks, radio technologies such as Bluetooth, DECT and particularly the IEEE802.11 standard for “Wireless Local Area Network” are used. Wireless communication may also be realized via infrared (IrDA) connections.

Similarly, networks used for informing or entertaining the user will in future also comprise, inter alia, apparatuses which communicate with each other in a wireless manner. Particularly, so-called ad hoc networks are mentioned, which are temporarily installed networks, generally with apparatuses of different owners. An example of such ad hoc networks can be found in hotels: for example, a guest may want to reproduce the pieces of music on his MP3 player via the stereo installation of the hotel room. A further example are all kinds of encounters in which people with communicating wireless apparatuses meet each other for exchanging data or media contents (images, films, music).

When using radio technologies, apparatuses such as, for example, an MP3 storage apparatus and a hi-fi installation can communicate with each other in a wireless manner via radio waves as data connection. Principally, there are two modes. The apparatuses either communicate with each other directly from apparatus to apparatus (as a peer-to-peer network) or via a central access point as a distributor station.

Dependent on the standard, the radio technologies have ranges of several tens of meters in buildings (IEEE802.11 up to 30 m) and several hundred meters in the open space (IEEE802.11 up to 300 m). Radio waves also penetrate the walls of a dwelling or a house. In the frequency coverage of a radio network, i.e. within its range, the transmitted information may principally be received by any receiver which is equipped with a corresponding radio interface.

This makes it necessary to protect wireless networks from unauthorized or unintentional listening in to, or eavesdropping on, the transmitted information, as well as from unauthorized access to the network and hence to its resources.

Methods of access control and protection of transmitted information are described in the radio standards (for example, in “IEEE802.11. Wireless LAN Medium Access Control (MAC) and Physical Layer (PHY) specifications. Standard, IEEE”, New York, August 1999, chapter 8). In radio networks and also especially in the IEEE802.11 standard, any form of data security is finally based on secret encryption codes (keys) or passwords which are only known to authorized communication partners.

Access control means that a distinction can be made between authorized and unauthorized apparatuses, i.e. an apparatus granting access (for example, an access point, or an apparatus of a home or ad hoc network getting a communication request) may decide by means of transmitted information whether an apparatus requesting access is authorized. In a medium such as radio, which can easily be listened in to, the simple transmission of access codes or the use of identifiers (which can be compared by the apparatus granting access with a list of identifiers of authorized apparatuses) is inadequate because an unauthorized apparatus can gain access to the required access information by listening in to this transmission.

The MAC address filtering used in connection with IEEE802.11 does not ensure safe protection in its simple form. In this method, the access point stores the list of the MAC (Media Access Control) addresses of the apparatuses which are authorized to access the network. When an unauthorized apparatus attempts to access the network, it will be refused because of the MAC address which is unknown to the access point. In addition to the unacceptable user-unfriendly but necessary management of a MAC address list for home networks, this method particularly has the drawback that it is possible to fake MAC addresses. An unauthorized user only needs to gain knowledge about an “authorized” MAC address, which is simply possible when eavesdropping on radio traffic. Access control is therefore coupled to an authentication which is based on a secret key or password.

The IEEE802.11 standard defines the “shared-key-authentication” in which an authorized apparatus is distinguished by knowing a secret key. The authentication is then performed as follows. To ascertain the authorization, the apparatus ensuring access sends a random value (challenge) which the apparatus requesting access encrypts with the secret key and sends it back. The apparatus granting access can thus verify the key and hence the access authorization (this method is generally also referred to as “challenge response method”).

During encryption, the transmitted information is encrypted by the transmitting apparatus and decrypted by the receiving apparatus so that the data are worthless for an unauthorized or unintentional listener. To this end, the IEEE802.11 standard uses the Wired Equivalent Privacy (WEP) encryption method. In this method, a key (40-bit or 104-bit WEP key) which is known to all apparatuses in the network but is otherwise secret is used as a parameter in the encryption algorithm, laid down in the IEEE802.11 standard for encrypting the data to be transmitted.

In the case of WEP, the same key is also used for authentication. In addition to “symmetrical” encryption methods (with a shared key) there are also public/private key methods in which each apparatus provides a generally known key (public key) for encryption and has an associated secret key (private key) which is known to this apparatus only, which provides the possibility of decrypting the information encrypted by means of the public key.

This provides listening security without a secret shared key which is known in advance. When using this method, it is, however, possible for an arbitrary apparatus to take up communication with an apparatus (for example, an apparatus granting access) while using the generally known key. Therefore, an authentication for access control is also required in this case which is again based on a secret key which should be known in advance to the communication partners.

For greater data security, network apparatuses may comprise mechanisms for agreements on temporary keys, i.e. keys used for encryption for a fixed period of time only so that the same secret key is not always used. However, the exchange of these temporary keys requires a listening-secure transmission which, in turn, requires at least a first secret key which should be known in advance to the communication partners. It is essential for the invention that the data security by way of encryption is also based on a (first) secret key which should be known in advance to the communication partners. Consequently, a configuration step making a secret key (for authentication and/or encryption) available for all relevant apparatuses is necessary for providing a security system for wireless networks.

A particular aspect of wireless networks is that this key should not be transmitted as clear text (unencrypted) via the wireless communication interface because an unauthorized apparatus may gain unauthorized access to the key by listening in. It is true that a coding method such as the Diffie-Hellman method ensures safety from interception of an agreement on a secret shared key between two communication partners via a radio interface. However, to prevent an unauthorized apparatus from initiating the key agreement with an (access-granting) apparatus of the network, this method must also be coupled to an authentication of the communication partner, which in turn requires a (first) secret key which should be known in advance to the communication partners.

In mobile telephones based on the DECT standard, a first key has already been stored by the manufacturer in the apparatuses (base station and listener). To identify a new listener for the base station, the key (PIN number) which is stored in the base station should be given by the user to the new listener. Since the user should know the key for this purpose, it is available, for example, on stickers on the base station.

IEEE802.11-based company or campus networks with a dedicated infra structure are generally configured by specialist system administrators. They generally use system management computers having wired connections with each access point. Via these wired connections (and hence quasi listening-secure) connections, the secret keys (for example, WEP keys) are transmitted to the access points. The key input to clients (for example, wireless laptops) is effected manually.

It is assumed that a configuration step for installing a first secret key is performed (and that the required configuration steps are defined in software interfaces), but their realization is not fixed. To this end, chapter 8.1.2 of the IEEE802.11 standard comprises the following statement: “The required secret shared key is presumed to have been delivered to participating STAs (stations) via a secure channel that is independent of IEEE802.11. The shared key is contained in a write-only MIB (Management Information Base) attribute via the MAC management path.”

A further problem which occurs in wireless communication between network components is the security or protection of property rights of digital information. Such a protection of digital data is ensured by a so-called Digital Rights Management (DRM). For example, applications such as “Pay TV” or “Pay Per View” are based on a decoding key which is typically stored on a chip card which is regularly (for example, monthly) sent to the user via the conventional postal channels. To read the chip card, a card reading apparatus is integrated in a decoder, which decoder can decrypt data sent in an encrypted form by the information provider, while using the decoding key. The decrypted data should not be transmitted in an unencrypted form outside the decoder because otherwise unauthorized use of the data, disregarding the property rights, would be possible.

However, consumers and manufacturers of apparatuses also want to be able to use the apparatuses of a wireless network for the reproduction of information at arbitrary places. The wireless transmission of information required for this purpose must, however, be protected from listening in and from abuse of data.

It is an object of the invention to realize a user-friendly installation of a secret key in the apparatuses of a preferably wireless network.

The object is solved by a security system for networks, particularly wireless networks, comprising

a (first) portable unit with a key unit for making a key record available and being provided for short-range information transmission of the key record, and

at least one receiving unit in at least one preferably wireless apparatus of the network, comprising a receiver for receiving the key record and an evaluation component of the apparatus for storing, processing and/or passing on the key record or a part of the key record to a second component.

Each wireless apparatus of the network comprises a radio interface for transmitting useful data as well as a receiving unit for receiving a key record from a first portable unit. To secure the wireless useful data traffic between the apparatuses, a key record is supplied free from interception to each apparatus, by which these apparatuses acquire a secret shared key with which the transmitted useful data and/or the authentication can be encrypted and decrypted. If required, a wired exchange of useful data can also be ensured with the secret shared key. Furthermore, this key may be used for protecting property rights of digital contents in that the associated data can be transmitted with a special encryption by the owner to the end apparatus.

The key record is made available by the key unit of the portable unit, comprising a transmitter or a transmitter with a detector unit for short-range transmission. The key record is thereby supplied free from interception to each wireless apparatus of the network. A button on the unit may be used for triggering the transmission of a key record. Dependent on the used method of short-range transmission of information, the transmission of a key record may also be triggered by bringing the unit into the vicinity of the receiving unit and by having the detector unit trigger the transmission of the key record.

The key record comprises a secret key code (“key”) as an essential (and possibly single) constituent. To receive the key record, each wireless apparatus of the network comprises a receiving unit which consists of a receiver and an evaluation component which, after acquiring the key record, extracts the key and passes on this key via an internal interface to the second component used for encrypting and decrypting the useful data (for example, the driver software used for controlling the radio interface).

A method of short-range transmission of information used by the portable unit may be based on modulated magnetic, electromagnetic fields such as infrared or visible light, ultrasound or infrasound or any other range-controllable transmission technologies. The transmission of the key record may also be realized by a multidimensional pattern on the surface of the transmitter, which is read by the receiving unit. It is essential for the invention that a technology having a very short range (few centimeters) or a short range and a strong local boundary (for example, infrared) is used so that the key record is supplied from a very short range and can in no case penetrate the walls of a room.

A particular advantage of this solution is that unauthorized persons cannot receive the key record. The transmission of the key record may be triggered by pressing a button on the portable unit or, for example, when using a radio frequency transponder technology (contactless RF tag technology) also by placing the portable unit in the vicinity of the receiving unit. By approaching the apparatus with the portable unit (or directing the unit onto the apparatus) and possible activation of a button on the unit, the input of the key record into an apparatus is thus very simple and uncomplicated for a user. The user neither needs to have any knowledge about the content of the key record or about the secret key. An expert for the input and administration of the key record is not necessary. The user friendliness is a further particular advantage of this solution.

Wireless networks, particularly home networks, should not only offer access for permanent users of the home network (for example, owners) but also provide, possibly limited, access for temporary users such as, for example, guests.

An advantageous further embodiment of the invention comprises a component denoted as key generator which is comprised in the key unit and used for generating additional key records. The key generator is an additional component of the first portable unit or is realized in a second separate portable unit.

A key record generated by the key generator, referred to as guest key record, is built up in such a way that it can always be distinguished (for example, by special bits in the key record) from a (home) key record stored in the memory of the unit. When inputting a key record it is also always clear whether it is a home key record input or a guest key record input. To this end, the portable unit with the memory and the key generator has at least two buttons (one for triggering the transmission of the home key record from the memory and one for triggering the transmission of a guest key record). When the key generator is realized in a separate second unit, it is unambiguously distinguishable (for example, by way of its color, inscription, etc.) from the unit with the home key record.

A guest key record is used to grant guests access to resources of the network. To this end, a guest key record is input to all relevant apparatuses of the home network (i.e. the apparatuses available for use in connection with the guest's apparatuses) and the guest's apparatuses (which do not belong to the home network). With the aid of this guest key record, the guest's apparatuses (for example, laptop) can communicate with the relevant apparatuses of the home network. In an alternative version, the guest key record is made known once to the network (for example, by inputting it into one of the apparatuses belonging to the network) and is to be inputted only in the guest's apparatuses when required; all apparatuses of the network are then available for use with the guest's apparatuses. The control as to which data within the available apparatuses the guest is granted access should be realized at another location.

To enable the user to control the duration of the granted guest access to the home network, the guest key record in the home network apparatuses is automatically erased after a fixed period of time or by means of user interaction. A user interaction for erasing a guest key record may be, for example, the re-input of the current home key record, pressing a special button on the relevant home network apparatuses or one of the relevant home network apparatuses and subsequent automatic information of all other relevant home network apparatus by this apparatus.

To prevent unauthorized use of a guest key record by a previous guest, the key generator automatically generates a new guest key record in accordance with the challenge response method after a fixed period of time (for example, 60 minutes) after the last transmission of the guest key record. A new guest thus receives a guest key record which is different from the previous one so that it is ensured that the previous guest cannot utilize the presence of the new guest for unauthorized access to the home network.

Ad hoc networks represent a further development of wireless networks in which a number of apparatuses is to be temporarily made available for communication in a shared network. Similarly as with guest access to the home network, in which individual guest apparatuses are made available for access to the home network by means of a guest key record, apparatuses of other users should be able to communicate with at least one apparatus of the user in an ad hoc network. To this end, the user inputs a key record, here referred to as ad hoc key record, into all apparatuses of the ad hoc network (his own apparatuses and those of the other users) The ad hoc key record may be a guest key record but may also be unambiguously characterized as an ad hoc key record.

It is preferred that the key records consist of bit sequences, in which each bit sequence is transmitted in a predefined format (for example, as 1024-bit sequence). The overall bit sequence or a part thereof is passed on as a key by the receiving unit. If the bit sequence comprises extra bits in addition to the key, it is exactly determined which part of the bit sequence is used as a key (for example, the 128 low-order bits) and which bits of the bit sequence comprise additional information. Further information may be characteristic features informing about the type of key record (home, guest, ad hoc, or decoding key record) or comprise details about the length and number of the key code if a plurality of key codes is transmitted simultaneously. If the receiving unit is used for further applications, the additional bits also characterize the use of the bit sequence as a key record.

In order to prevent use of the same (home) key in two neighboring home networks, it should be globally unambiguous. This can be achieved, for example, in that different unit manufacturers use different ranges of values for key codes and, in so far as possible, do not store the same key record within these ranges in two units at a time.

A network operating in accordance with the IEEE802.11 standard is a widely known example of wireless home networks. In an IEEE802.11 network, the key record to be transmitted may comprise one or more Wired Equivalent Privacy (WEP) keys.

The input of the (home) key record may also take place in steps for the purpose of configuring the network so that the input/installation of the key record is desired at the start of the configuration. During the overall configuration process, an interception-free mutual communication between the apparatuses as well as an access control (all apparatuses having the key record are authorized) is thus ensured. This is particularly advantageous when applying automated configuration methods, i.e. methods without any user interaction (based on mechanisms such as, for example, IPv6 autoconfiguration and Universal Plug and Play (UPnP)).

In a preferred embodiment, the portable unit is integrated in a remote control unit of an apparatus of the home network.

As already stated, the key unit may comprise a memory for storing a worldwide unambiguous key record. When using the security system for protecting property rights of digital data, it is preferred when the key unit comprises a reading device for reading a mobile data memory. The mobile data memory may be particularly a chip card on which a decoding key record is stored and which is regularly made available to the authorized users (for example, by conventional post) by the provider of the digital information to be protected. By equipping the portable unit with a card reader, it is possible to make the decoding key record available to different apparatuses of a (wireless) network without these apparatuses themselves having to comprise an integrated card reader.

In accordance with a further development of the embodiment described above, the key unit may not only comprise the reading device but also a writing device with which data can be written into the mobile data memory. This particularly provides the possibility of filing information in the mobile data memory about the extent of using the digital information to be protected.

Furthermore, the portable unit and the apparatus of the network may be adapted to transmit a confirmation from the apparatus to the unit, which confirmation indicates the (positive or negative) consequence of performing an instruction transmitted by the unit to the apparatus in advance. For example, the confirmation may indicate whether a key record transmitted from the unit to the apparatus has been received and installed successfully or not successfully. Likewise, the confirmation may indicate whether the instruction of erasing a key record installed in an apparatus has been performed successfully or not successfully. The confirmations thus allow the portable unit to keep track of the installation and activity of transmitted key records on the apparatus.

A confirmation of performing an instruction preferably comprises an identification code which unambiguously identifies the apparatus transmitting the confirmation, and thus supports the tracking function of the portable unit.

In accordance with a further embodiment of the security system comprising a mobile data memory, the key unit of the portable unit may be adapted to

store useful data in the mobile data memory, allowing the management of key records read from the data memory and installed on apparatuses, and

block the transmission of a key record from the mobile data memory to an apparatus in case said useful data comply with a predetermined criterion.

The embodiment of the security system described hereinbefore provides the possibility of a very comprehensive protection of property rights of digital data. This is realized, on the one hand, in that all useful data relating to the use of a decoding key record stored in the mobile data memory are again filed in the mobile data memory. Together with the mobile data memory, it is thus always known how often the decoding key record has already been installed on any apparatus or on different apparatuses, or is active on these apparatuses. When these useful data comply with a predetermined criterion, the further transmission of key records from the mobile data memory to an apparatus can be blocked. For example, the criterion may be that the key record should not be installed on more than N (=1, 2, 3, . . . ) different apparatuses and may be active. Another important aspect is that the required useful data are filed in the mobile data memory itself (and not in, for example, the portable unit) so that the limitations of using the decoding key records cannot be evaded by substituting the mobile data memory for another read apparatus.

Furthermore, the portable unit may comprise a triggering unit whose activation causes the apparatus to erase a key record. In this way, it is possible, for example, to de-install a decoding key record previously transmitted to the apparatus so that the decoding key record can be re-installed elsewhere while maintaining the limitations of use.

The invention also relates to a portable unit for installing a preferably shared key in at least one apparatus of a particularly wireless) network comprising a key unit for making a key record available and being provided for short-range information transmission of the key record.

The unit can be particularly further developed in such a way that it is possible to use it in a security system of the type described above.

Furthermore, the invention relates to an electric apparatus with a receiving unit comprising a receiver for receiving a key record and an evaluation component of the apparatus for storing, processing and/or passing on the key record or a part of the key record to a second component.

The electric apparatus can be particularly further developed in such a way that it is possible to use it in a security system of the type described above.

These and other aspects of the invention are apparent from and will be elucidated with reference to the embodiments described hereinafter.

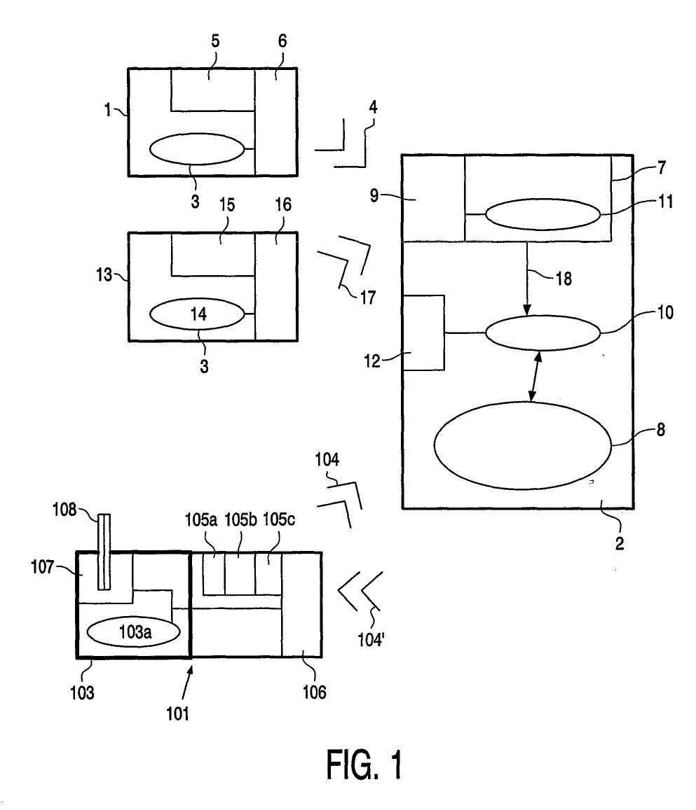

FIG. 1 shows diagrammatically three units and one apparatus

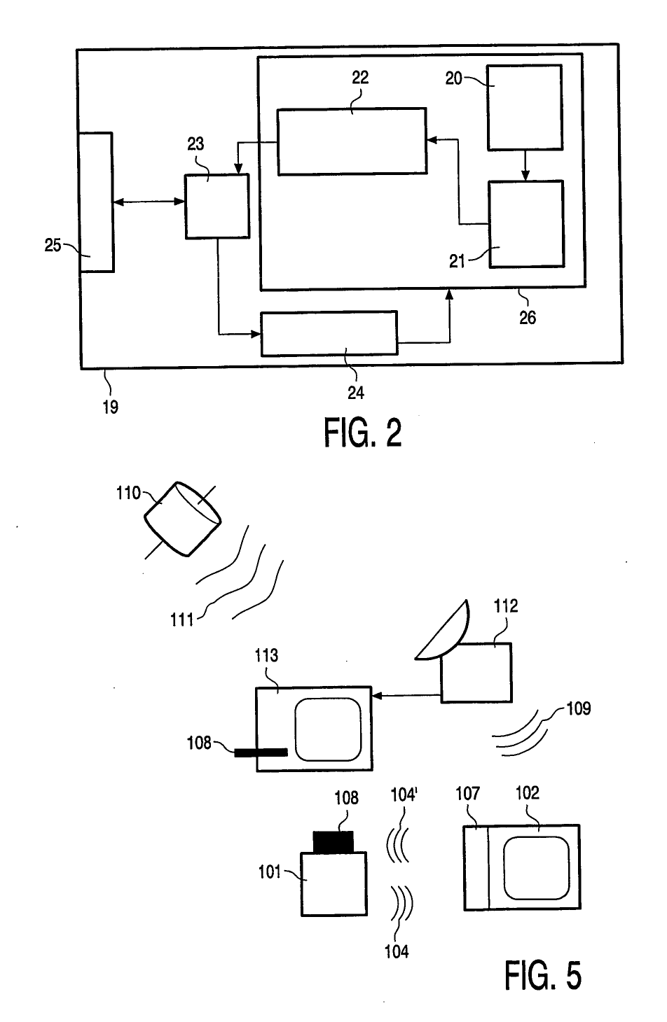

FIG. 2 is a block diagram of a unit as a transmitting unit when using RF transponder technology,

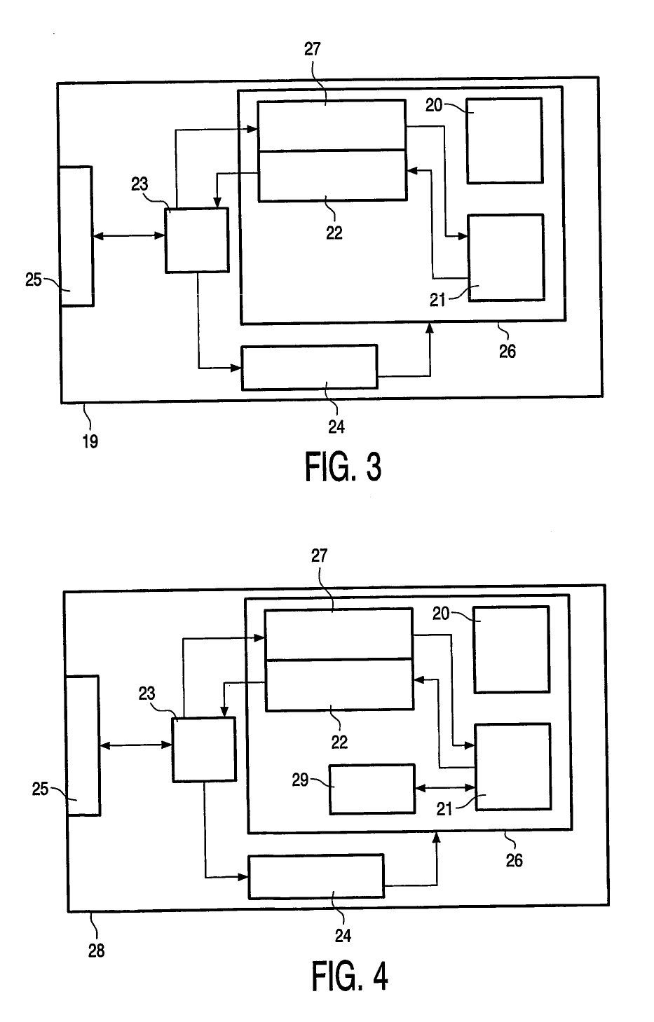

FIG. 3 is a block diagram of a unit as a receiving and transmitting unit when using RF transponder technology,

FIG. 4 is a block diagram of a unit as a guest unit when using RF transponder technology, and

FIG. 5 shows the use of the security system for Digital Rights Management (DRM).

The installation of an electric apparatus in a home network, here consisting of wireless and wired apparatuses (not shown) will be described with reference to FIG. 1. The Figure shows a first, portable unit 1, a guest unit 13, a DRM unit 101 and a personal computer (PC) 2 as an apparatus which is new in the home network. All of the wireless apparatuses in the home network have corresponding components 8 to 12 described by way of the PC 2 example.

The first unit 1 comprises a key unit in the form of a memory 3 for storing a key record 4, a first button 5 as a unit for triggering a key transmission and a first transmitter 6 used as a wireless interface for transmitting the key record 4. The unit 1 has a short range of maximally about 50 cm.

The guest unit 13 comprises a key unit 3 and a component denoted as key generator 14 for generating key records, for example, in accordance with the challenge response principle, a second button 15 and a second transmitter 16. The guest unit 13 enables guests with their own apparatuses (not belonging to the home network) to have, possibly limited, access to the apparatuses and applications of the home network. A key record generated by the key generator 14 is therefore denoted as guest key record 17.

The DRM unit 101 comprises a key unit 103 with a memory 103a for storing a key record, and a write/read device 107 which can read and write an inserted chip card 108. Furthermore, the DRM unit 101 has a first button 105a with which the transmission of a (home) key record from the memory 103a can be triggered, a second button 105b with which the transmission of a key record can be erased by the chip card 108, a third button 105c with which an instruction for erasing a key record can be sent to an apparatus, and a transmitting/receiving unit 106 for transmitting key records 104 to an apparatus and for receiving feedback signals 104′ from the apparatus. The operation of the DRM unit 101 will be further elucidated with reference to FIG. 5.

The PC 2 is an apparatus equipped with a radio interface 12 operating in accordance with the IEEE802.11 standard. This radio interface 12 is controlled by a component denoted as driver software 10 and is used for transmitting useful data (music, video, general data, but also control data). The driver software 10 may be operated by other software components via standardized software interfaces (APIs). The PC 2 is also equipped with a receiving unit 7. The receiving unit 7 comprises a receiver 9 provided as an interface for receiving the key record 4, 17 or 104 transmitted by transmitter 6, 16 or 106. The receiving unit 7 is provided with receiver software 11 as an evaluation component which, after obtaining a key record, extracts a key 18 therefrom (for example, a Wired Equivalent Privacy (WEP) key defined in the IEEE802.11 standard) and passes on this key 18 via a standardized management interface (as MIB (Management Information Base) attribute in the IEEE802.11 standard) to the driver software 10. The PC 2 is provided with application software 8 required for operating the PC.

A user would like to install the PC 2 in the home network and radio-connect it to a hi-fi installation in the home network in order that he can play back a plurality of music files in MP3 format on the hi-fi installation, which MP3 files are stored in the PC 2. To this end, the user approaches the PC 2 with the unit 1 and starts a transmission of the key record 4 stored in the memory 3 by directing the transmitter 6 of the unit 1 from a distance of several centimeters at the receiver 9 and pressing the button 5 on the unit 1.

When transmitting the key record 4, infrared signals are used. The format of the key record 4 is a 1024-bit sequence from which the receiver software 11 extracts the 128 low-order bits and passes them on as a (WEP) key 18 to the driver software 10. In the driver software 10, this key 18 is used for encrypting the data traffic between the PC 2 and the hi-fi installation as well as other apparatuses which have also been fed with the key record 4. This also relates to the required communication with the apparatuses already present in the network, subsequent to the autoconfiguration of the network connection of the PC to the home network (for example, configuration of an IP address).

Different circumstances may require the installation of a new key, for example when the user has lost the unit, when a new apparatus must be installed or when the user suspects that his home network is no longer protected. Fundamentally, a new unit with a new key record can overwrite the latest input of the (old) key record, for which the new key record must then be supplied to all apparatuses of the home network.

Abusive input of a new key record into the home network may be prevented in that at least one apparatus of the home network is not freely accessible to unauthorized persons. After unauthorized input of the new key record into the other apparatuses of the home network, this apparatus can no longer communicate with these apparatuses and trigger, for example, a corresponding alarm.

To enhance the security of the home network, it may, however, be compulsory that the old key record 4 must be additionally supplied with the input of a new key record. To this end, the user approaches the PC 2 or another apparatus in the home network with the old and the new unit. The user presses the button 5 on the old unit 1 for (re-)transmission of the old key record 4. A short moment later, the user starts the transmission of the new key record by pressing the button on the new unit for triggering the transmission.

The receiver software 11 of the PC 2 registers the reception of the old key record 4 and subsequently receives the new key record. The receiver software 11 passes on the new key record or the key via the management interface to the driver software 10 of the radio interface 12 only on condition that the receiver software 11 has previously registered the reception of the old key record 4. In order that the data traffic can be encrypted on the basis of the new key, the new key record must be supplied, as described above, to all apparatuses of the home network.

An increased extent of security when inputting a new key record can be achieved when the receiver software 11 only accepts the input of a new key record, i.e. passes on the key in this record, when the new key record has been supplied several times and at certain time intervals to the apparatus, the number of times and time intervals of the required inputs being known to the user only.

An increased extent of security of the home network may also be achieved in that a key record must be regularly supplied again to at least one of the apparatuses of the home network after expiration of a given period of time (several days/weeks/months).

By means of the guest unit 13, the user can grant a guest access to the PC 2. To this end, the guest or the user approaches the PC 2 and, by pressing the button 15, triggers the transmission of the guest key record 17 generated by the key generator 14.

The guest key record 17 consists of a bit sequence with additional bits for transmitting further information. The additional bits characterize the key record as guest key record and are used for distinguishing the key record from other information if the receiving unit is used as an interface for further applications.

The receiving unit 7 receives the guest key record 17. The receiver software 11 identifies the key record by way of the additional bits as guest key record 17 and passes on the extracted key as an additional (WEP) key via the management interface to the driver software 10 of the radio interface 12. The driver software 10 uses the key as an additional key for encrypting the data traffic.

In the Wired Equivalent Privacy (WEP) encryption defined in the IEEE802.11 standard, a parallel application of up to four WEP keys is provided. The apparatuses of the network are capable of recognizing which WEP key is currently used for encryption.

The input of the guest key record 17 is repeated for all apparatuses of the home network which the guest would like to use, as well as for all apparatuses of the guest (for example, laptop) with which he would like to get access to the home network, for example, to the MP3 files on the PC 2.

To enable the user to control the duration of the granted guest access to the home network, the guest key record 17 is automatically erased in the apparatuses of the home network after a fixed period of time (for example, 10 h) or by user interaction (for example, input of the home key record 4 into the home network apparatuses).

To prevent unauthorized use of a guest key record by a previous guest, the key generator automatically generates a new guest key record in accordance with the challenge response principle after a fixed period of time.

FIG. 2 is a block diagram of a portable unit 19 for use with a RF transponder technology for transmitting the key record 4. The portable unit 19 consists of a digital part 26 comprising a memory 20 (such as, for example, ROM) for storing the key record, a program run control unit 21 and a modulator 22 for converting a bit stream coming from the program run control unit 21 into RF signals to be transmitted. Furthermore, the unit 19 comprises a splitter 23 for separating the electromagnetic energy received from a passive component designated as an antenna 25 from the RF signal to be transmitted, a power supply unit 24 with a voltage detector for supplying the digital part 26 with an operating voltage and the antenna 25 for transmitting the bit stream coming from the splitter 23 and for receiving the energy required for operation.

To transmit the key record 4, the user approaches the receiving unit 7 with the portable unit 19. The antenna 25 passes on the incoming energy from the receiving unit 7 via the splitter 23 to the power supply unit 24 with the voltage detector. When a threshold value of the voltage is exceeded in the voltage detector, the power supply unit 24 provides an operating voltage in the unit 19. Excited by the operating voltage, the program run control unit 21 is initialized and reads the key record stored in the memory 20. The key record is embedded in an appropriate message format by the program run control unit 21 and passed on to the modulator 21 for conversion into analog RF signals. The RF signals are transmitted by the antenna 25 via the splitter 23.

FIG. 3 shows the unit 19 as a receiving and transmitting unit while applying the same technology as in FIG. 2. In this Figure, identical or corresponding elements and components have the same reference numerals as those in FIG. 2. In so far, reference is made to the description of FIG. 2 and only the differences will be elucidated hereinafter.

In this embodiment, the unit 19 comprises the modulator 21 as well as a demodulator 27. The memory 20 is realized by an erasable memory such as, for example, an electrically erasable memory of an EEPROM.

Due to the demodulator 27, the unit 19 is capable of converting an RF signal received by the antenna 25 (additionally to the incoming energy) and passed on via the splitter 23 into a bit sequence. The bit sequence coming from the demodulator 27 is processed by the program run control unit 21. The processing of the bit sequence may result in an access of the program run control unit 21 to the memory 20 if the program run control unit 21 determines that the bit sequence comprises information authorizing the receiving unit to receive the key record. If the receiving unit is authorized to receive the key record, the program run control unit 21 reads the key record and passes it on, in the manner as described in FIG. 2, to the antenna 25 for transmission.

The demodulator 27 further provides the possibility of introducing a new key record into the unit 19. When the memory 20 is realized as a writable memory (for example, EEPROM), the key record in the unit 19 can be replaced by a new key record.

FIG. 4 shows the unit 19 as a guest unit 28 while applying the same technology as in FIG. 2. In this Figure, identical or corresponding elements and components are also denoted by the same reference numerals as those in FIG. 3. In so far, it will be described with reference to FIG. 3 and only the differences will be elucidated hereinafter.

The guest unit 28 additionally comprises a key generator 29 which is connected to the program run control unit 21 and is used for generating a sequence of guest key records.

After the energy coming in through the antenna 25 in the vicinity of the receiving unit 7 is detected with the voltage detector in the power supply unit 24, the digital unit 26 is supplied with an operating voltage by the power supply unit 24. The program run control unit 21 reads a key record generated by the key generator 29. After the program run control unit 21 has received the key record and has embedded it in an appropriate message format, it passes on this record for transmission to the modulator 22 and simultaneously writes the key record into the memory 20 which must be formed as a writable memory (for example, EEPROM) for this purpose.

In a second mode of operation, a new key record is generated by the key generator within regular intervals (for example, several minutes or hours) and stored in the rewritable memory 20. The further procedure then corresponds to that described with reference to FIGS. 2 and 3.

The embodiment of the unit 19 with the key generator as shown in FIG. 4 can also be combined with the embodiment (without the demodulator 27) shown in FIG. 2.

FIG. 5 shows diagrammatically the components employed when using the security system for protecting property rights of digital data. Currently, the protection of property rights or the Digital Rights Management (DRM) is realized as follows. The provider of digital data 111 (for example, Pay TV) transmits these data, for example, via a satellite 110 in an encrypted form with a key which is known to him only. The encrypted data 111 can be received by an appropriate receiver 112 and can be passed on to an apparatus 113 such as, for example, a set top box. To be able to use the contents of the encrypted data, the apparatus 113 should know the secret key of the data provider. This key is made available via a chip card 108 which is mailed by the data provider to the authorized and paying users, for example, once a month. The chip card 108 may then be inserted into a card reader connected to the apparatus 113, whereupon the apparatus 113 can read and use the decoding key record stored on the card. A characteristic feature of this system is that the data to be protected must not leave the apparatus 113 in a digital, unencrypted form in order that their use is coupled with the possession of the chip card 108 and is thus controllable.

However, in modern digital networks, it is becoming increasingly desirable to use data on different apparatuses, particularly on wireless apparatuses coupled to a network. To prevent the use of card readers on each one of such apparatuses, the DRM unit 101 (FIG. 1, FIG. 5) is used. As already elucidated with reference to FIG. 1, this unit comprises a card reader 107 (similar to the SIM card readers in mobile telephones) which can read and preferably also write the chip card 108. The DRM unit 101 can therefore read particularly the decoding key record filed on the chip card 108 and transmitted to the corresponding receiver 107 of an apparatus 102 via a short-range transmission. The apparatus 102 (when it comprises the corresponding software) can then decrypt the encrypted data 109 by means of the decoding key record 104, sent (via a wireless connection) by the above-mentioned satellite receiver 112. The use of these data 109 is therefore also possible on the apparatus 102 without this apparatus needing its own card reading device.

The system described may further be developed in that it prevents unauthorized multiple transmission of a decoding key record 104 to different apparatuses. In accordance with a first embodiment, this can be realized in such a way that the decoding key record 104 on the apparatus 102 expires or is automatically erased within regular, proportionally short time intervals so that it must be retransmitted quasi steadily by the DRM unit 101. Simultaneous use of a plurality of apparatuses would then be substantially excluded.

In a more sophisticated control of using apparatuses, a bi-directional communication is performed between the DRM unit 101 and the apparatus 102. Whenever the apparatus 102 has received and successfully installed a key record 104 from the DRM unit 101, it responds by means of a confirmation 104′ which indicates the successful transfer of the key record and comprises an identification code ID for the apparatus 102. This ID is then stored on the chip card 108 by the DRM unit 101. When a predetermined permitted number of apparatuses that can be activated is reached (this number may be filed on, for example, the chip card), the DRM unit 101 can recognize this and, in reaction thereto, may no longer transmit any further decoding key record 104 to any other apparatus.

A re-transmission of decoding key records by the DRM unit 101 will not become possible until after the number of apparatuses with activated key records has decreased. This may be the case, for example, automatically after termination of predetermined time intervals. However, the DRM unit 101 preferably comprises an “erase button” 105c (FIG. 1) which, after having been pressed, brings about an interaction with a target apparatus 102. The DRM unit 101 first demands the ID of the apparatus 102. The apparatus 102 thereupon sends its ID which is received by the DRM unit 101 and is compared with the IDs, stored on the chip card 108, of apparatuses with activated key records. If the ID is present on the card, the DRM unit sends an instruction to the apparatus 102 to erase the decoding key record in the apparatus. A confirmation thereupon transmitted by the apparatus 102 informs the DRM unit 101 whether the erasure was performed as desired, or was not performed. If the key record has been erased successfully, the ID of the apparatus 102 can be erased from the chip card 108 so that subsequent use of the decoding key record on another apparatus is possible.

1. A security system for networks, particularly wireless networks, comprising
a portable unit (1, 13, 101) with a key unit (3, 103) for making a key record (4, 17, 104) available and being provided for short-range information transmission of the key record (4, 17, 104), and
at least one receiving unit (7, 107) in at least one apparatus (2, 102) of the network, comprising a receiver (9) for receiving the key record (4, 17, 104) and an evaluation component (11) of the apparatus for storing, processing and/or passing on the key record (4, 17, 104) or a part of the key record to a second component.

2. A security system as claimed in claim 1, characterized in that the unit (1, 13, 101) comprises at least one triggering unit (5, 15, 105a, 105b, 105c) for triggering a short-range transmission of information, particularly a short-range information transmission of the key record (4, 17, 104).

3. A security system as claimed in claim 1, characterized in that, upon a user's approach to the receiving unit (7, 107), a detector unit in the unit (1, 13, 101) triggers the short-range information transmission of the key record (4, 17, 104).

4. A security system as claimed in claim 1, characterized in that the key unit (3) comprises a key generator (14) for generating a sequence of guest key records (17).

5. A security system as claimed in claim 1, characterized in that the apparatus (2, 102) is provided for erasing the key record (17, 104).

6. A security system as claimed in claim 1, characterized in that the key record (4, 17, 104) consists of a bit sequence.

7. A security system as claimed in claim 6, characterized in that the bit sequence comprises characterizing bits used for distinguishing and characterizing key records (4, 17, 104).

8. A security system as claimed in claim 1, characterized in that the unit (1, 13, 101) is a part of an apparatus, particularly a remote control unit.

9. A security system as claimed in claim 1, characterized in that the key record (4, 17, 104) is supplied during or before a network configuration, particularly an automatic network configuration, of an apparatus (2, 102).

10. A security system as claimed in claim 1, characterized in that the apparatus (2, 102) is provided for authentication, encryption and/or decryption, by means of a key in the key record (4, 17, 104), of useful data (109) transmitted between the apparatuses of the network.

11. A security system as claimed in claim 1, characterized in that the key unit comprises a memory (3, 103a) for storing a worldwide unambiguous key record (4, 104).

12. A security system as claimed in claim 1, characterized in that the key unit (103) comprises a reading device (107) for reading a mobile data memory, particularly a chip card (108) having a decoding key record (104) stored thereon.

13. A security system as claimed in claim 12, characterized in that the key unit (3) comprises a writing device (107) for writing data into the mobile data memory (108).

14. A security system as claimed in claim 1, characterized in that the unit (101) and the apparatus (2, 102) are adapted to transmit a confirmation (104′) by the apparatus (2, 102) to the unit (101), indicating the consequence of performing an instruction transmitted from the unit (101) to the apparatus (2, 102).

15. A security system as claimed in claim 14, characterized in that the confirmation (104′) comprises an identification code for the apparatus (2, 102).

16. A security system as claimed in claim 13, characterized in that the key unit (3) is adapted to
store useful data in the mobile data memory (108), allowing the management of key records (104) read from the data memory (108) and installed on apparatuses (2, 102), and
block the transmission of a key record (104) from the mobile data memory (108) to an apparatus (2, 102) in case said useful data comply with a predetermined criterion.

17. A security system as claimed in claim 5, characterized in that the unit (101) comprises a triggering unit (105c) whose activation causes the apparatus (2, 102) to erase a key record (104).

18. A portable unit (1, 13, 101) for installing a key in at least one apparatus (2, 102) of a wireless network comprising a key unit (3, 103) for providing a key record (4, 17, 104) which is provided for short-range information transmission of the key record.

19. An electric apparatus (2, 102) with a receiving unit (7, 107) comprising a receiver (9) for receiving a key record (4, 17, 104) and an evaluation component (11) of the apparatus (2, 102) for storing, processing and/or passing on the key record or a part of the key record to a second component (10).
